(19) United States
(12) Patent Application Publication
(10) Pub. No.: US 2012/0268935 A1
(43) Pub. Date: Oct. 25, 2012

(54) LIGHT-EMITTING DIODE LIGHTING DEVICE

(76) Inventors: CHIEN-YUAN CHEN, New Taipei City (TW); YING-TE CHUANG, New Taipei City (TW)

(21) Appl. No.: 13/089,322

(22) Filed: Apr. 19, 2011

(51) Int. Cl. F21V 21/00; F21V 29/00

(52) U.S. Cl. 362/249.02

(57) ABSTRACT

A light-emitting diode (LED) lighting device includes a base, which has an end forming a head portion and an opposite end forming a lighting body. The lighting body includes a support plate having an end coupled to the base and supporting multiple thermal conduction bars. Each thermal conduction bar carries one or more lighting assemblies. The lighting assembly includes a bracket and a light source unit. The light source unit is set to project light of uniform brightness in a given direction. The grating like three-dimensional lighting device features light weight and excellent air ventilation and heat dissipation and allows an LED lighting device to be adopted in an existing fixture.

### TECHNICAL FIELD OF THE INVENTION

The present invention generally relates to a light-emitting diode (LED) lighting device, which is applicable to, but not limited to street lamps with high brightness and excellent heat dissipation, and more particularly to a lighting device that is compatible with existing standard of street lamp.

### DESCRIPTION OF THE PRIOR ART

A street lamp is an essential kind of public facility and must be structured to provide sufficient brightness and illumination and being weather resistant. Due to being exposed to outdoor environments, the street lamp must be of a special and safe configuration. The long term experience of setting up and operating street lamp shows that a basic configuration is available for the lamp street. An example is shown in FIG. 9, wherein a street lamp has a top portion forming a dome like hood 70 (often made of metal) and a curved convex cover 71 (often made of glass). A light bulb 60, which has a diameter approximately 39 mm, is received and retained between the hood 70 and the cover 71. The top portion is supported by a support arm 51 and a pole 50 to form the street lamp. Such a configuration of street lamp provides certain advantages. However, such a conventional street lamp makes the light bulb 60 projecting light in a radiating form, whereby light L2 emits from an upper side of impinges the hood 70 first and is then reflected toward ground, leading to certain extent of deterioration of illumination. Light L1 emitting from a lower side of the light bulb 60 is projected in a radiating and spread fashion, which leads to poor illumination at the area just below the street lamp. Such a known arrangement, as a whole, is not an idea design and can provide a lighting efficiency of around 40-60% observed in tests. Further, the outline of the conventional street lamp, although effective in resisting poor weather and dust invasion, is of poor performance of heat dissipation. This is a significant drawback of the conventional street lam.

To improve the street lamp, various light-emitting diode (LED) based lighting devices have been recently available. However, an LED only emits light in a frontward direction and does not project light in a radiating form as a conventional light bulb. Thus, when an LED lighting device is used as a street lamp, the existing fixture of the conventional street lamp must be completely replaced by a new fixture. This requires a complete replacement of all the existing fixtures and the associated parts/components, which leads to a waste and requires a great budget. Apparently, such a solution is not environmentally friendly. Further, a known LED based street lamp arranges LEDs in an array to serve as a light source, and such an arrangement provides only a limited area of illumination exactly under the street lamp and a surrounding zone around such a limited area of illumination gets dimmed in brightness. Apparently, the overall illumination of the known LED based street lamp is poor and brightness is not uniform. This is a major drawback of the known LED street lamp and must be overcome.

### SUMMARY OF THE INVENTION

The primary objective of the present invention is to provide a lighting device that has a grating like configuration of three-dimensional arrangement resembling a regular light bulb and comprises a plurality of lighting assemblies for projection of light beam to the ground so that a light source unit of each of the lighting assemblies projects light in a direction away from a hood within a wide range and shows uniform brightness, and at the same time provides the features of light weight and excellent air ventilation and heat dissipation and being compatible with the existing fixtures of conventional lighting devices, such as street lamps.

To achieve the objective, the following solution is adopted:

A lighting device comprises a base, which has an end forming a head portion and an opposite end forming a lighting body. The lighting body comprises a support plate that has an end coupled to the base and supports multiple thermal conduction bars thereon. Each thermal conduction bar carries a number of lighting assemblies. Each lighting assembly comprises a bracket and a light source unit. The light source unit is set to project light in a direction that is opposite to a hood of the lighting device within a wide range.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG 1 is a perspective view of a light-emitting diode (LED) lighting device according to the present invention.

FIG. 2 is another perspective view of the LED lighting device according to the present invention.

FIG. 3 is an exploded view of the LED lighting device according to the present invention.

FIG. 4 is a lateral cross-sectional view of the LED lighting device according to the present invention.

FIG. 5 is a longitudinal cross-sectional view of the LED lighting device according to the present invention.

FIG. 6 is a schematic view illustrating connection between a thermal conduction bar and a lighting assembly of the LED lighting device according to the present invention.

FIG. 7 is a schematic view illustrating a different form of lighting assembly of the LED lighting device according to the present invention.

FIG. 8 is a schematic view illustrating a further different form of lighting assembly of the LED lighting device according to the present invention.

FIG. 9 is a schematic view showing a conventional street lamp.

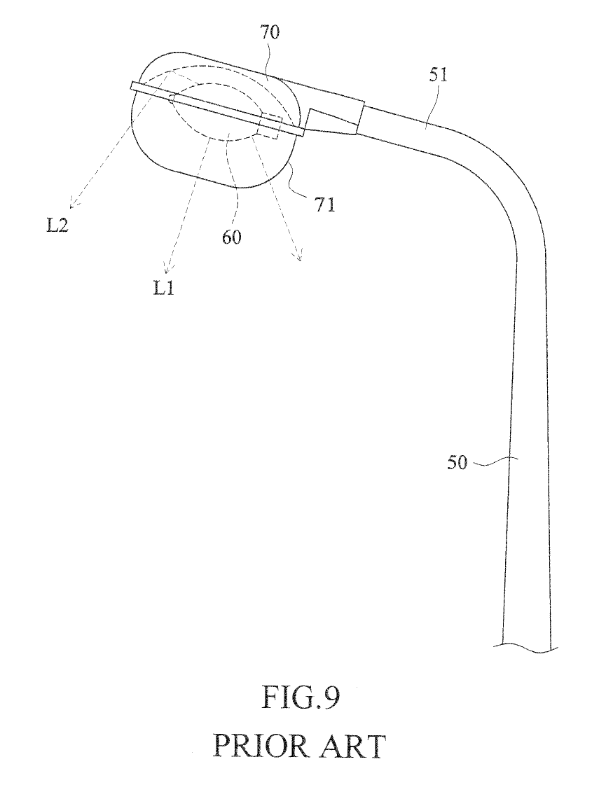

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

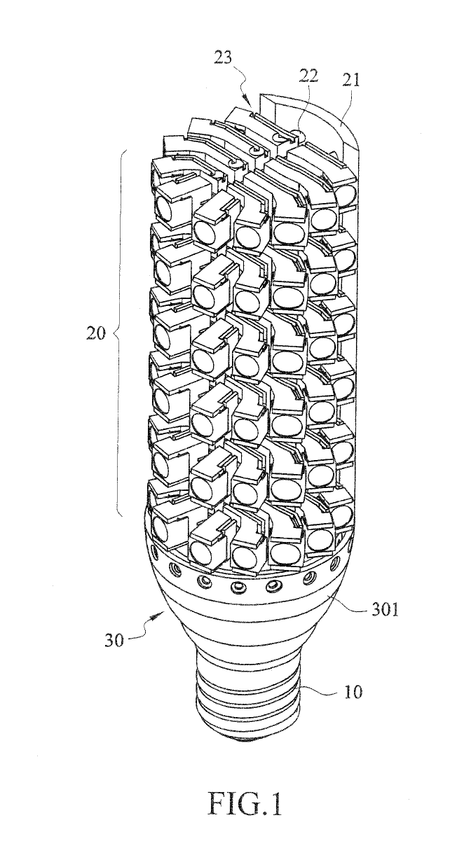

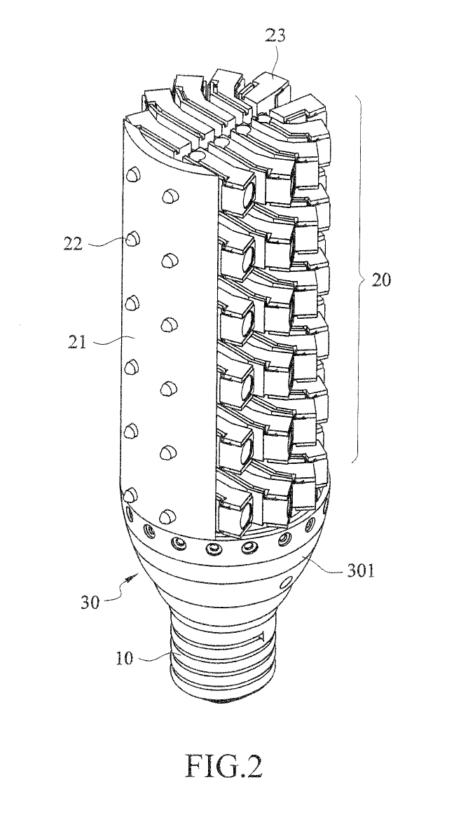

Referring to FIGS. 1 and 2, which show different perspective views of a light-emitting diode (LED) lighting device constructed in accordance with the present invention, the LED lighting device comprises a base 30, which receives and retains circuits and electrical components (not shown) essential to the lighting device therein. The base 30 has an end forming a head portion 10 and an opposite end forming a lighting body 20. As shown in FIG. 1, preferably a rotary device 301 is provided between the base 30 and the head portion 10 to allow the base 30 to be selectively rotated for adjusting light emission direction. The rotary device 301 can be formed of any known device and means, so that details are not needed herein.

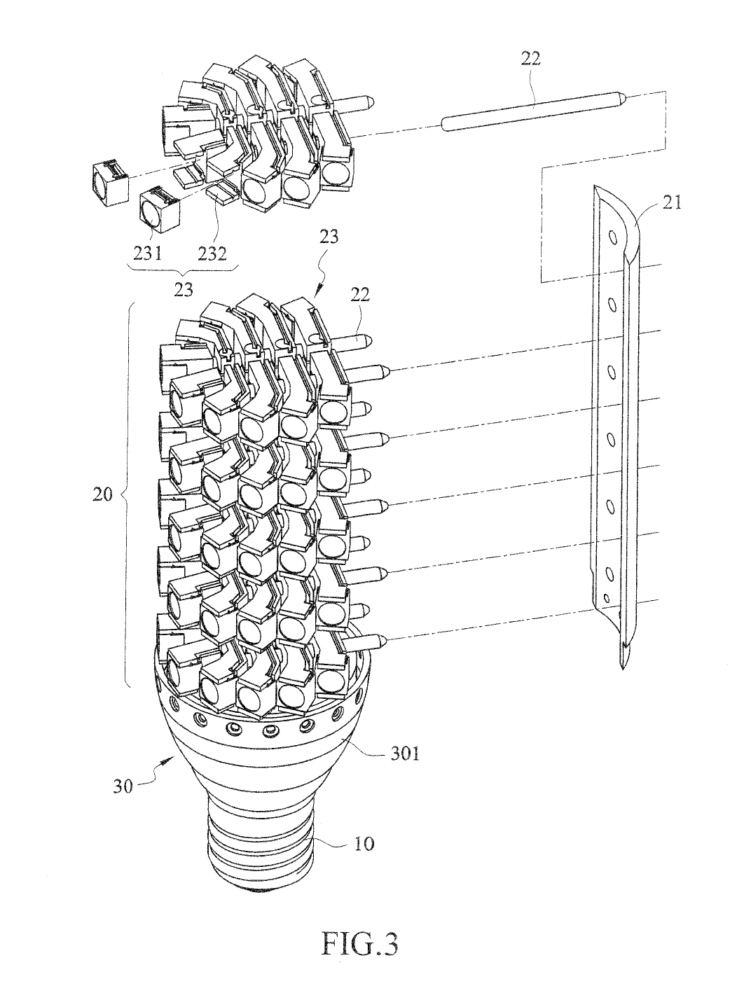

Besides FIGS. 1 and 2, reference is also made to FIG. 3, which is an exploded view of the LED lighting device of the present invention.

The lighting body 20 comprises at least a support plate 21, which has an end coupled to the base 30. The support plate 21 can of any shape and is not limited to an elongate member as shown in the drawings, and can be for example a curved tubular shape.

A plurality of thermal conduction bars 22 is provided. The thermal conduction bars 22 are made of heat pipes or metals bars that are of excellent heat dissipation characteristics (such as bar made of aluminum or copper or any alloy thereof). Each thermal conduction bar 22 has an end fixed to the support plate 21. The arrangement of attaching the thermal conduction bars can be symmetric or asymmetric. In the embodiment illustrated, the arrangement of the thermal conduction bars comprises two symmetric rows, each comprising six bars, preferably equally spaced from each other. Other arrangements can be adopted, as desired.

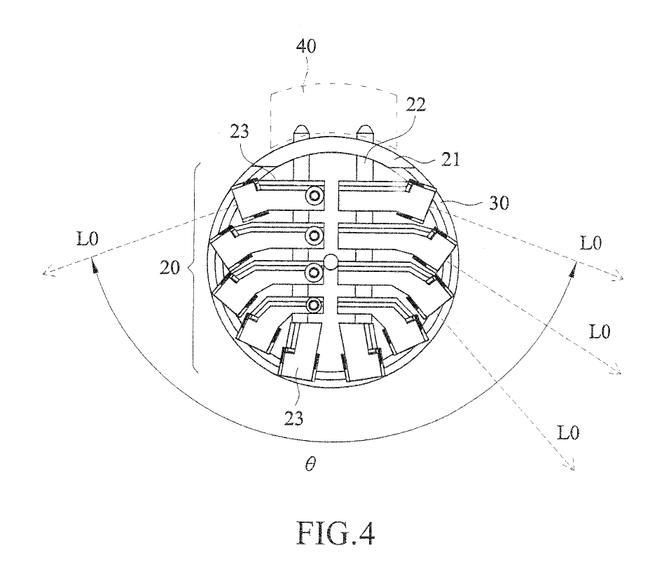

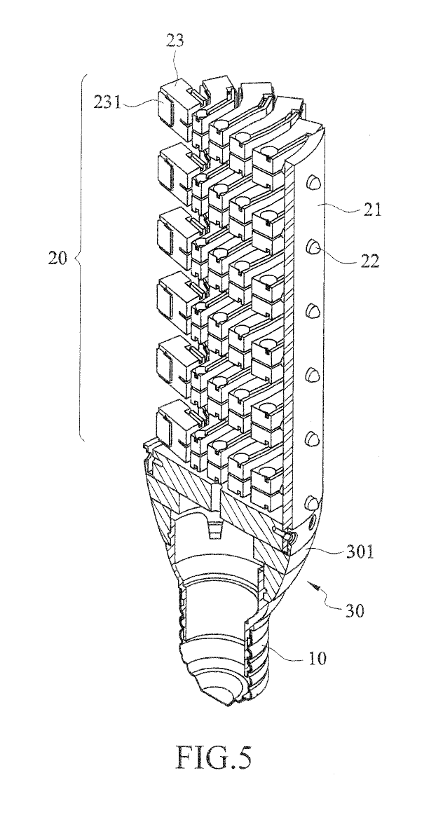

Referring to FIGS. 4, 5, and 6, which are respectively a lateral cross-sectional view a longitudinal cross-sectional view of the LED lighting device of the present invention and a schematic view illustrating an example of one of a plurality of lighting assemblies 23 included in the LED lighting device of the present invention, the plurality of lighting assemblies 23 is respectively mounted to the thermal conduction bars 22. Each lighting assembly 23 comprises a bracket 232 and a light source unit 231. The bracket 232 has an end fixed to an associated one of the thermal conduction bars 22 and an opposite end carrying the light source unit 231 that is comprised of an LED. The shape or configuration of the bracket 232 gives certain influence on the angle of projection of light beam from the light source unit 231. In the embodiment illustrated in FIG. 4, an example of the configuration of brackets 232 is given, wherein multiple lighting assemblies 23 are mounted to each of the thermal conduction bars 22 in such a manner that each of the light source units 231 projects a light beam L0 in a different direction. In a practical embodiment, each of the brackets 232 and the light source unit 231 carried thereby form an angular bend of a different angle therebetween. The different angular bends allow light emission faces of the light source units 231 carried by the brackets to be set at different angular positions and distributed in a spaced fashion by predetermined distances therebetween. Such a “multi-layered” distribution realizes wide-angle projection light in the side opposite to a hood of the lighting device, whereby the light source unit 231 of each of the lighting assemblies 23 projects light to an area where illumination is desired and illumination of uniform brightness can be realized. Such an arrangement can be alternatively achieved through proper configuration of the brackets 232, or further alternatively, the light source units 231 can be of such a structure that is adjustable for angular position and/or that is mounted in a fixed or alternating fashion, to thereby provide diverse variations.

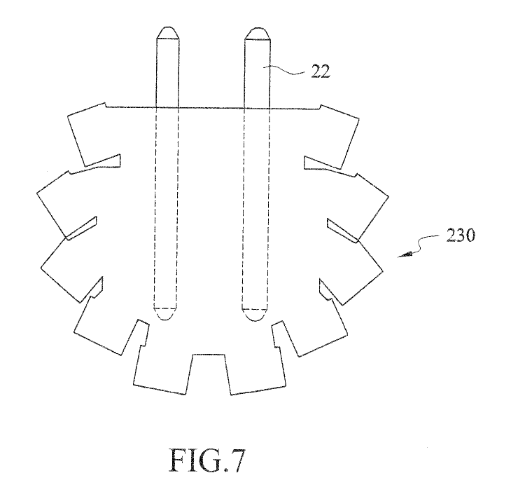

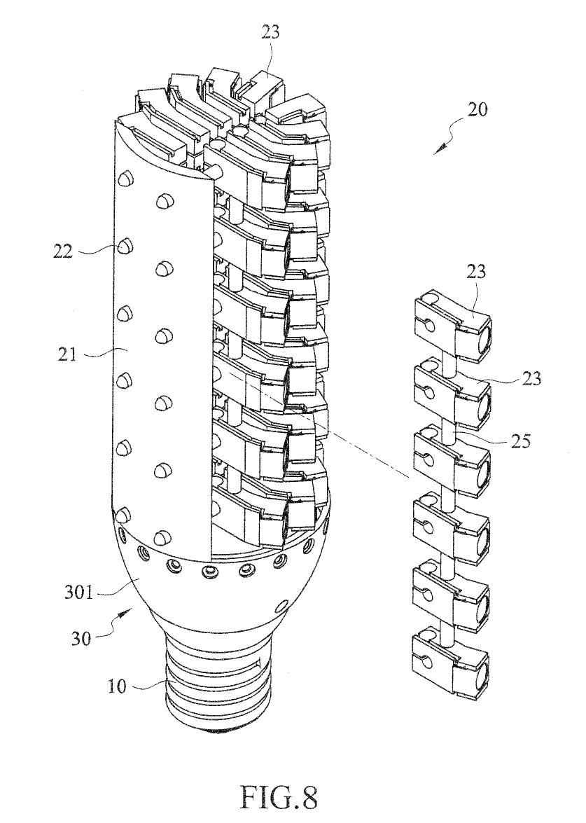

For easy assembly and manufacture, multiple lighting assemblies 23 can be made integrally as a unitary structure. For example, the lighting assemblies 23 that are located on the same cross-section of the lighting body 20 are combined together to a single combined lighting assembly 230 shown in FIG. 7. Further, the plurality of the lighting assemblies 23 shown in FIGS. 1 and 2 can be alternatively arranged in the form illustrated in FIG. 8, wherein a connection bar 25 that extends in a longitudinal direction of the lighting body 20 to connect a number of the lighting assemblies 23 to form a combined unit. In other words, the lighting assemblies 23 of the lighting body 20 that are located on the same longitudinal cross-section are combined together. Further, several such combined units may be further combined, or even integrated together, to form an expanded combination that may constitutes one half of the lighting body 20. These three alternative configurations discussed above all help reducing the number of parts/component and making assembling easy.

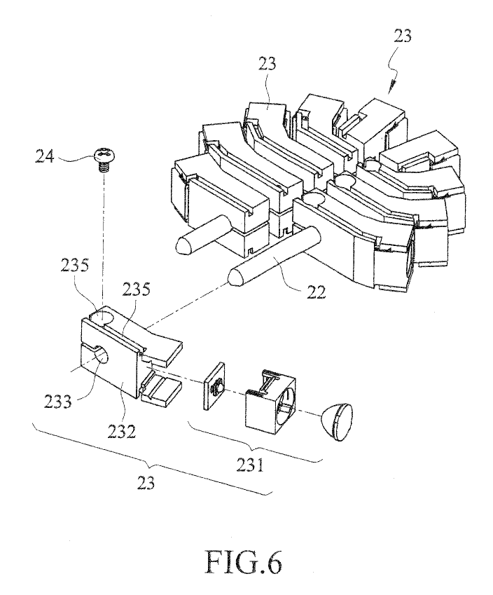

FIG. 6 discloses the connection between the bracket 232 and the thermal conduction bar 22, which can be realized through welding, threading engagement, or clamping. In the embodiment illustrated, the bracket 232 forms, in an end portion thereof, a clamp hole 233, which receives the thermal conduction bar 22 therein. The bracket 232 also forms, in a side face thereof, a locking hole 234, which receives and engages a fastener 24 (such as a bolt or a screw) for securing. The bracket 232 may be provided in the side face thereof with one or more wire channels 235, which receive extension of wires of the light source unit 231 therethrough.

As shown in FIG. 4, if desired, the present invention may further provide a heat dissipater 40, which can be any known dissipation device and is shown in phantom lines, to be attached to an outside surface of the support plate 21 shown in FIG. 2. Heat generated by the operation of light emission of the lighting assembly 23 is conducted through the thermal conduction bar 22 to the support plate 21. Although this process effectively dissipates a certain amount of heat, the remaining heat can be further conducted to the heat dissipater 40 for further dissipation so that excellent heat dissipation can be realized for the lighting device.

The present invention provides the following advantages:

(1) As shown in FIG. 4, the ends of the lighting assemblies 23, where the light source units 231 project light beams, are arranged so that the light beams L0 projected are distributed in a spaced fashion and set at different angles within a given angular range θ. This makes the light source unit 231 of each of the lighting assemblies 23 projecting light toward a predetermined area in a uniform manner so that illumination of uniform brightness may be realized at a specific direction without any waste of light energy

(2) The lighting assembly 23 according to the present invention can realize variable projection angle through proper configuration of a bracket 232 in combination with the use of thermal conduction bars 22. This provides an achievement beyond the conventional LED array that projects light only in a frontward direction so that the present invention provides three-dimensional arrangement of projection angle and realizes easy control uniformity and breadth of light projection.

(3) The present invention provides thermal conduction bars 22, each of which is coupled with a number of lighting assemblies 23 in a cascade but spaced fashion so that ventilation space is present in the lighting device for air flows and heat may not be entrapped in the lighting device and heat dissipation is improved.

(4) As shown in FIGS. 1 and 2, the lighting assembly 23 is an LED based lighting assembly 23, but configured as a three-dimensional elliptic “light bulb” outline, which has a the head portion 10 that is compatible to the existing lighting fixture, so that the present invention can be used in such a manner that the existing fixture can be saved and preserved.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A light-emitting diode (LED) lighting device, comprising a base, which has an end forming a head portion and an opposite end forming a lighting body, the lighting body comprising at least:
a support plate, which has an end coupled to the base;
a plurality of thermal conduction bars, each of which has an end attached to the support plate; and
a plurality of lighting assemblies, at least one of which is mounted to each of the thermal conduction bars, each of the lighting assemblies comprising a bracket and a light source unit that comprises an LED, the bracket being mounted to the thermal conduction bar and having an opposite end carrying the light source unit.

2. The LED lighting device according to claim 1, wherein the support plate comprises an elongate member.

3. The LED lighting device according to claim 1, wherein the support plate comprises a curved tubular member.

4. The LED lighting device according to claim 1, wherein the thermal conduction bars comprise heat pipes.

5. The LED lighting device according to claim 1, wherein the thermal conduction bars comprise metal bars.

6. The LED lighting device according to claim 1, wherein the thermal conduction bars are attached to the support plate to form a symmetric arrangement.

7. The LED lighting device according to claim 1, wherein each of the thermal conduction bars carries a number of the lighting assemblies thereon so that each of the light source units projects a light beam in a different direction.

8. The LED lighting device according to claim 1, wherein the bracket has an end forming a clamp hole.

9. The LED lighting device according to claim 1, wherein the bracket forms at least one wire channel.

10. The LED lighting device according to claim 1, wherein the support plate has an outside surface to which a heat dissipater is mounted.

11. The LED lighting device according to claim 1, wherein a rotary device is arranged between the base and the head portion.

12. The LED lighting device according to claim 1, wherein the thermal conduction bars that are located on a common lateral cross section of the lighting body are respectively provided with multiple ones of the lighting assemblies, the multiple ones of the lighting assemblies being combined together.

13. The LED lighting device according to claim 1, wherein the thermal conduction bars that are located on a common longitudinal cross section of the lighting body are respectively provided with multiple ones of the lighting assemblies, the multiple ones of the lighting assemblies being combined together to form a combined unit.

14. The LED lighting device according to claim 13, wherein the combined units are connected to each other to constitute one half of the lighting body.
